(19) United States
(12) Patent Application Publication
(10) Pub. No.: US 2009/0291330 A1
(43) Pub. Date: Nov. 26, 2009

(54) Battery with enhanced safety

(75) Inventors: Per Onnerud, Framingham, MA (US); Yanning Song, Chelmsford, MA (US); Richard V. Chamberlain, II, Fairfax Station, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Boston-Power, Inc., Westborough, MA (US)

(21) Appl. No.: 12/386,270

(22) Filed: Apr. 15, 2009

Related U.S. Application Data
(60) Provisional application No. 61/125,327, filed on Apr. 24, 2008.

(51) Int. Cl. H02H 7/18; H01M 4/82; H02J 7/00

(52) U.S. Cl. 429/7; 29/623.1; 320/137

(57) ABSTRACT

A battery includes a cell casing; a first terminal; a second terminal in electrical communication with the cell casing and electrically insulated from the first terminal; an electrode assembly in the cell casing; a current interrupt device (CID) in electrical communication with the first terminal and the first electrode or with the second terminal and the second electrode; and insulation that interrupts potential electrochemical communication between the first electrode and the second terminal or between the second electrode and the first terminal. The electrode assembly includes a first electrode in electrical communication with the first terminal, a second electrode in electrical communication with the second terminal, and an electrolyte between the first and second electrodes. The insulation interrupts potential electrochemical communication between the first electrode and the second terminal or between the second electrode and the first terminal when under a charging or overcharging condition and when the CID is activated, thereby interrupting the electrical communication between the first terminal and the first electrode or between the second terminal and the second electrode.

### RELATED APPLICATION

This application claims the benefit of U.S. Provisional Application No. 61/125,327, filed on Apr. 24, 2008. The entire teachings of the above application are incorporated herein by reference.

### BACKGROUND OF THE INVENTION

Rechargeable batteries, such as lithium-ion rechargeable batteries, are widely used as electrical power for battery-powered portable electronic devices, such as cellular telephones, portable computers, camcorders, digital cameras, PDAs and the like. A typical lithium-ion battery pack for such portable electronic devices employs multiple cells that are configured in parallel and in series. For example, a lithium-ion battery pack may include several blocks connected in series where each block includes one or more cells connected in parallel. Each block typically has an electronic control that monitors voltage levels of the block. In an ideal configuration, each of the cells included in the battery pack is identical. However, when cells are aged and cycled, they tend to deviate from the initial ideal conditions, resulting in an unbalanced cell pack (e.g., unidentical capacity, impedance, discharge and charge rate). This unbalance among the cells may cause over-charge or over-discharge during normal operation of the rechargeable batteries, and in turn can impose safety concerns, such as explosion (i.e., rapid gas release and possibility for fire). Although there have been a various types of safety measures have been designed and employed, unfortunate accidents associated with batteries, such as explosion, have been reported in the art.

Therefore, there is a need to develop new batteries with enhanced safety.

### SUMMARY OF THE INVENTION

In one embodiment, the present invention is directed to a battery that comprises a cell casing; a first terminal; a second terminal in electrical communication with the cell casing and electrically insulated from the first terminal; an electrode assembly in the cell casing; a current interrupt device in electrical communication with the first terminal and the first electrode or with the second terminal and the second electrode; and insulation that interrupts potential electrochemical communication between the first electrode and the second terminal or between the second electrode and the first terminal. The electrode assembly includes a first electrode in electrical communication with the first terminal; a second electrode in electrical communication with the second terminal; and an electrolyte between the first and second electrodes. The current interrupt device includes a first conductive component and a second conductive component in electrical communication with each other, wherein the electrical communication between the first and second conductive components is interrupted when a gauge pressure between the two components is in a range of between about 4 kg/cm² and about 15 kg/cm². The insulation interrupts potential electrochemical communication between the first electrode and the second terminal or between the second electrode and the first terminal when under a charging or overcharging condition and when the electrical communication between the first and second conductive components of the current interrupt device has been interrupted to thereby interrupt the electrical communication between the first terminal and the first electrode or between the second terminal and the second electrode.

In another embodiment, the present invention is directed to a battery pack that comprises at least one cell and at least one charger that charges the cell. Each cell includes a cell casing; a first terminal; a second terminal in electrical communication with the cell casing and electrically insulated from the first terminal; an electrode assembly in the cell casing; a current interrupt device in electrical communication with the first terminal and the first electrode or with the second terminal and the second electrode; and insulation that interrupts potential electrochemical communication between the first electrode and the second terminal or between the second electrode and the first terminal. The features of the electrode assembly, the current interrupt device and the insulation are each independently as described above for a battery of the invention. The charger is in electrical communication with the first terminal or the second terminal of the cell.

In yet another embodiment, the present invention is directed to a method of minimizing increase of internal pressure of at least one cell of a battery pack under a charging or overcharging condition. The method comprises: a) charging at least one cell of the battery pack with a charger of the battery pack that is in electrical communication with a first terminal or a second terminal of the cell, the first and the second terminals being in electrical communication with a first electrode and a second electrode of an electrode assembly of the cell, respectively; b) interrupting electrical communication between the first terminal and the first electrode of the cell or between the second terminal and the second electrode of the cell by a current interrupt device; and c) interrupting potential electrochemical communication between the first electrode and the second terminal or between the second electrode and the first terminal with insulation. The current interrupt device includes a first conductive component and a second conductive component in electrical communication with each other. The interruption of the electrical communication between the first terminal and the first electrode of the cell or between the second terminal and the second electrode of the cell occurrs when a gauge pressure between the first and second components of the current interrupt device is in a range of between about 4 kg/cm² and about 15 kg/cm².

In yet another embodiment, the present invention is directed to a method of forming a battery, comprising the step of forming insulation as a component of the battery. The battery further includes a current interrupt device in electrical communication with a first terminal and a first electrode, or with a second terminal and a second electrode, of the battery, wherein the current interrupt device includes a first conductive component and a second conductive component in electrical communication with each other, the electrical communication between the first and second conductive components being interrupted when a gauge pressure between the conductive components is in a range of between about 4 kg/cm² and about 15 kg/cm². The insulation interrupts potential electrochemical communication between the first electrode and the second terminal or between the second electrode and the first terminal of the battery when under a charging or overcharging condition and when the electrical communication between the first and the second components of the current interrupt device has been interrupted to thereby interrupt the electrical communication between the first terminal and the first electrode or between the second terminal and the second electrode.

Generally when a lithium-ion cell (or battery) are in an overcharge abuse condition, a current interrupt device (CID) activates after the cell internal pressure reaches the pre-designed activating pressure, such as between about 4 kg/cm² and about 15 kg/cm². A CID typically includes two conductive components (e.g., plates), wherein one is connected to a terminal outside of the cell (or battery) and the other is connected to one of the two electrodes inside the cell. When the CID activates, the electrical connection between the outside terminal and the inside electrode is interrupted. However, even after the CID activation, current can still flow through the cell when the cell is still connected to a charger that has been charging the cell. Without being bound to a particular theory, it is believed that current flow can be provided between the conductive component of the CID (which is connected to the outside cell terminal) and the anode or cathode of the cell (which is connected to the other conductive component of the CID) via electrolytes of the cell. Such current flow can cause decomposition of the electrolytes, which in turn contribute to continuous increase of the internal cell pressure even after the CID activation, which can cause explosion of the cell.

With the present invention, the above-mentioned, potential electrochemical pathway between the first electrode and the second terminal or between the second electrode and the first terminal is interrupted, when under a charging or overcharging condition and when the CID is activated to thereby interrupt the electrical communication between the first terminal and the first electrode or between the second terminal and the second electrode. Thus, the present invention provides improved safety to a battery or to a battery pack including a plurality of batteries (or cells), such that the internal pressure of the battery does not continue building up after the CID activation.

The batteries and battery packs of the invention can be used for portable power devices, such as portable computers, power tools, toys, portable phones, camcorders, PDAs and the like. In portable electronic devices using batteries, their charges are, in general, designed for a 4.20 V charging voltage. Thus, the batteries and battery packs of the invention are particularly useful for these portable electronic devices.

### BRIEF DESCRIPTION OF THE DRAWINGS

FIG. 1 is a schematic view of a prismatic battery of the invention.

FIG. 2A shows a top view of the prismatic battery of FIG. 1.

FIG. 2B shows a side view of the lid of the prismatic battery of FIG. 1.

FIG. 3 shows a schematic view of a cylindrical battery of the invention.

FIG. 4 is a schematic circuitry showing how individual cells in the invention are preferably connected when arranged together in a battery pack of the invention.

FIG. 5 shows one embodiment of a battery of the invention that employs a thermal fuse.

FIG. 6 shows another embodiment of a battery of the invention that employs a thermal fuse.

FIG. 7 shows one embodiment of a battery of the invention that employs a non-porous, non-conductive wrap or tape.

FIG. 8A shows one embodiment of a battery of the invention that employs a non-porous, non-conductive coating.

FIG. 8B shows another embodiment of a battery of the invention that employs a non-porous, non-conductive coating.

FIG. 9 shows one embodiment of a battery of the invention that employs a non-porous, non-conductive sleeve.

FIG. 10 shows one embodiment of a battery of the invention that employs a non-porous, non-conductive bag.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

As used herein, the “terminals” of the batteries of the invention mean the parts or surfaces of the batteries to which external electric circuits are connected.

The batteries of the invention typically include a first terminal in electrical communication with a first electrode, and a second terminal in electrical communication with a second electrode. The first and second electrodes are contained within a cell casing, for example, in a “jelly roll” form. The first terminal can be either a positive terminal in electrical communication with a positive electrode of the battery, or a negative terminal in electrical communication with a negative electrode of the battery, and vice versa for the second terminal. In one embodiment, the first terminal is a negative terminal in electrical communication with a negative electrode of the battery, and the second terminal is a positive terminal in electrical communication with a positive electrode of the battery.

As used herein, the phrase “electrically connected” or “in electrical communication” or “electrically contacted” means certain parts are in communication with each other by flow of electrons through conductors, as opposed to electrochemical communication which involves flow of ions, such as Li⁺, through electrolytes.

As used herein, the phrase “electrochemical communication” means communication between certain parts through electrolyte media and involves flows of ions, such as Li⁺.

A CID that can be employed in the invention can be activated at an internal gauge pressure in a range of, for example, between about 4 kg/cm² and about 15 kg/cm² (e.g., between about 4 kg/cm² and about 10 kg/cm², between about 4 kg/cm² and about 9 kg/cm², between about 5 kg/cm² and about 9 kg/cm² or between 7 kg/cm² and about 9 kg/cm²). As used herein, “activation” of the CID means that current flow of an electronic device through the CID is interrupted. In a specific embodiment, the CID of the invention includes a fist conductive component and a second conductive component in electrical communication with each other (e.g., by welding, crimping, riveting, etc.). In this CID, “activation” of the CID means that the electrical communication between the first and second conductive components is interrupted. The first and second components of the CID can be in any suitable form, such as a plate or disk.

In some embodiments, the first conductive component of the CID is in electrical communication with the second conductive component, and in electrical and pressure (i.e., fluid such as gas) communication with the cell casing of the battery. In a specific embodiment, the first conductive component includes a cone- or dome-shaped part. In another specific embodiment, at least a portion of the top (or cap) of the cone- or dome-shaped part is essentially planar. In yet another specific embodiment, the first and second conductive components of the CID are in direct contact with each other at a portion of the essentially planar cap. In yet another specific embodiment, the first conductive component includes a frustum having an essentially planar cap, as described in U.S. Provisional Application No. 60/936,825, filed on Jun. 22, 2007 (the entire teachings of which are incorporated herein by reference).

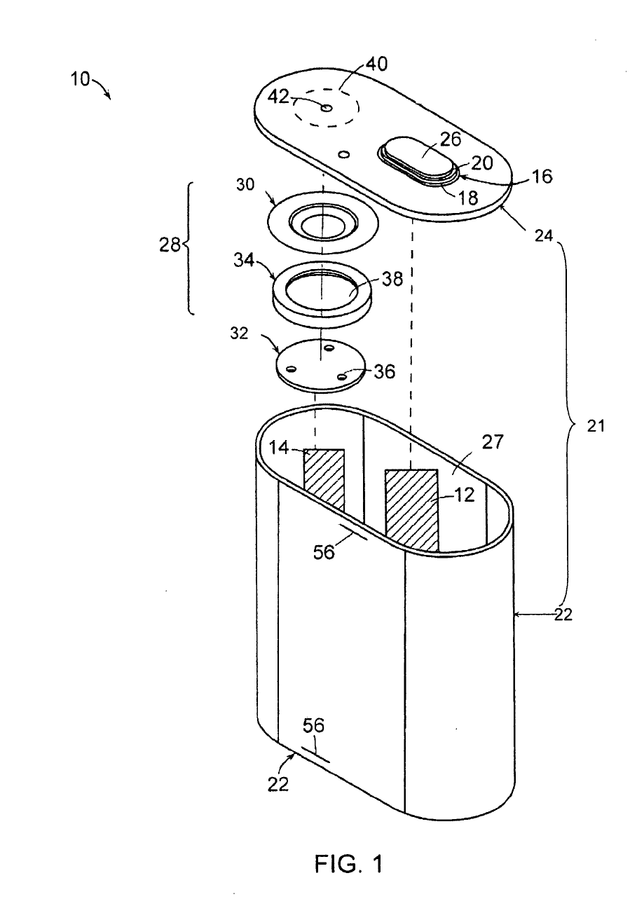

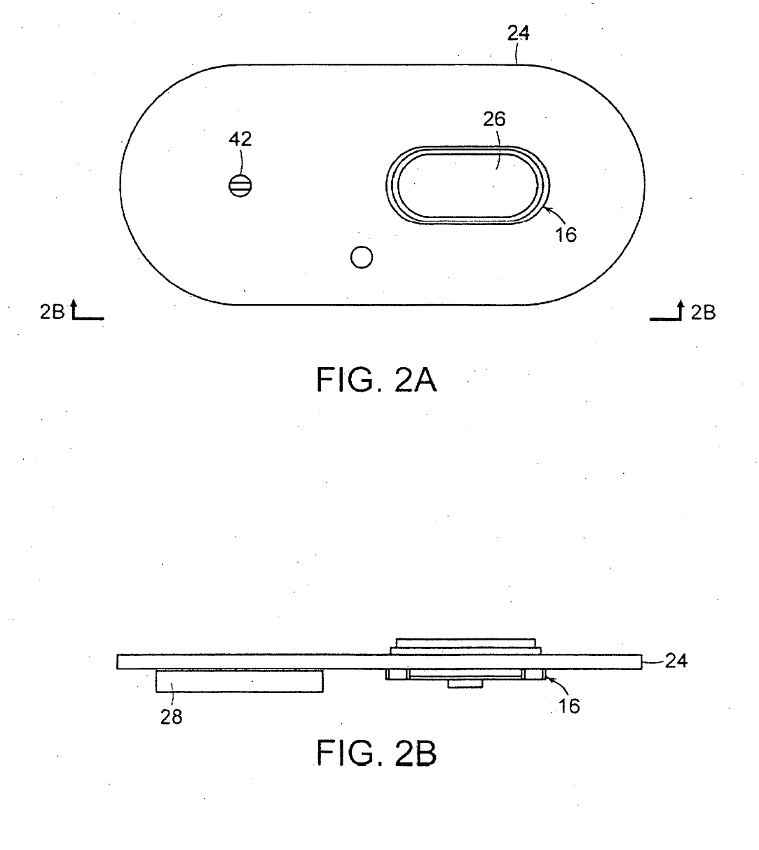

One specific embodiment of CIDs that can be employed in the invention is shown in FIG. 1. FIGS. 2A and 2B show a top view and cross-sectional view of the lid of battery 10 of FIG. 1, respectively. As shown in FIG. 1, battery 10 includes first electrode 12 and second electrode 14. First electrode 12 is electrically connected to feed-through device 16, which includes first component 18, which is proximal to first electrode 12, and second component 20, which is distal to first electrode 12. Feed-through device 16 can further include conductive layer 26. The electrodes 12 and 14 are placed inside battery can 21 that includes cell casing 22 and lid 24, i.e., internal space 27 defined by cell casing 22 and lid 24. Cell casing 22 and lid 24 of battery 10 are in electrical communication with each other.

CID 28 includes first conductive component 30 and second conductive component 32 in electrical communication with each other (e.g., by welding, crimping, riveting, etc.). Second conductive component 32 is in electrical communication with second electrode 14, and first conductive component 30 is in electrical contact with battery can 21, for example, lid 24. Battery can 21, i.e., cell casing 22 and lid 24, is electrically insulated from a first terminal of battery 10 (e.g., electrically conductive layer 26), and at least a portion of battery can 21 is at least a component of a second terminal of battery 10, or is electrically connected to the second terminal. In one specific embodiment, at least a portion of lid 24 or the bottom of cell casing 22 serves as the second terminal of battery 10, and conductive layer 26 serves as the first terminal of battery 10.

CID 28 can further include insulator 34 (e.g., insulating layer or insulating gasket) between a portion of first conductive component 30 and second conductive component 32.

In one specific embodiment, at least one of second conductive component 32 and insulator 34 of CID 28 includes at least one hole (e.g., holes 36 or 38 in FIG. 1) through which gas within battery 10 is in fluid communication with first conductive component 30.

In another specific embodiment, CID 28 further includes end component (e.g., plate) 40 disposed over first conductive component 30, and defining at least one hole 42 through which first conductive component 30 is in fluid communication with the atmosphere outside the battery. End component 40 (e.g., a plate or disk) can be a part of battery can 21, as shown in FIG. 1 where end component 40 is a part of lid 24 of battery can 21. Alternatively, end component 40 can be a separate component from battery can 21, and be placed at battery can 21, for example, over, under or at lid 24 of battery can 21.

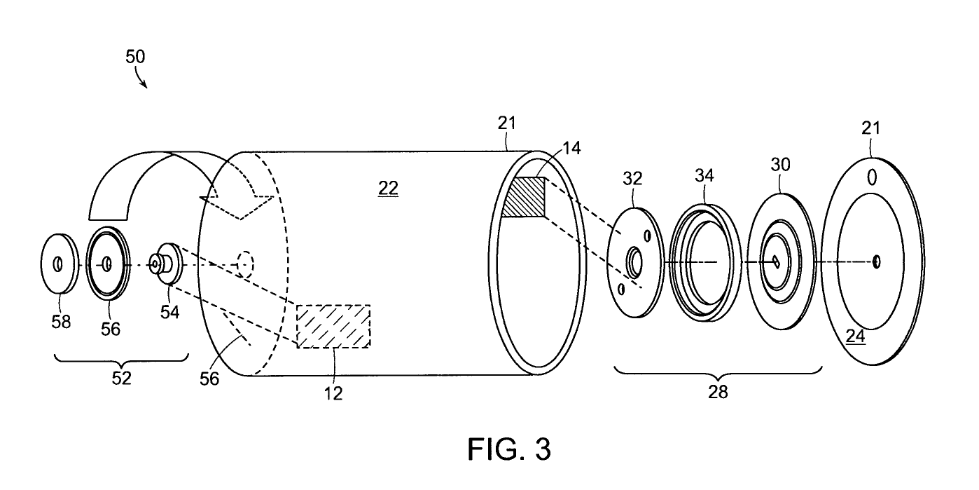

FIG. 3 shows another embodiment of CID assemblies that can be employed in the invention. As shown in FIG. 3, battery 50 includes CID 28, battery can 21 that includes cell casing 22 and lid 24, first electrode 12 and second electrode 14. First electrode 12 is in electrical communication with a first terminal of the battery (e.g., conductive component 58), and second electrode 14 is in electrical communication with a second terminal of the battery (e.g., lid 24). Cell casing 22 and lid 24 are in electrical contact with each other. The tabs (not shown in FIG. 3) of first electrode 12 are electrically connected (e.g., by welding, crimping, riveting, etc.) to electrically-conductive, first component 54 of feed-through device 52. The tabs (not shown in FIG. 3) of second electrode 14 are in electrically connected (e.g., by welding, crimping, riveting, etc.) to second conductive component 32 of CID 28. Feed-through device 52 includes first conductive component 54, which is electrically conductive, insulator 56, and second conductive component 58, which can be the first terminal of battery 50.

In battery 50, battery can 21, i.e., cell casing 22 and lid 24, is electrically insulated from a first terminal of battery 50 (e.g., conductive component 58), and at least a portion of battery can 21 is at least a component of a second terminal of battery 50, or is electrically connected to the second terminal. In one specific embodiment, at least a portion of lid 24 or the bottom of cell casing 22 serves as the second terminal of battery 50, and conductive component 58 serves as the first terminal of battery 50.

Although FIGS. 1-3 show CID assemblies where CID 28 is in electrical communication with second electrode 14, a CID assembly where a CID, such as CID 28, is in electrical communication with first electrode 12 can also be employed in the invention.

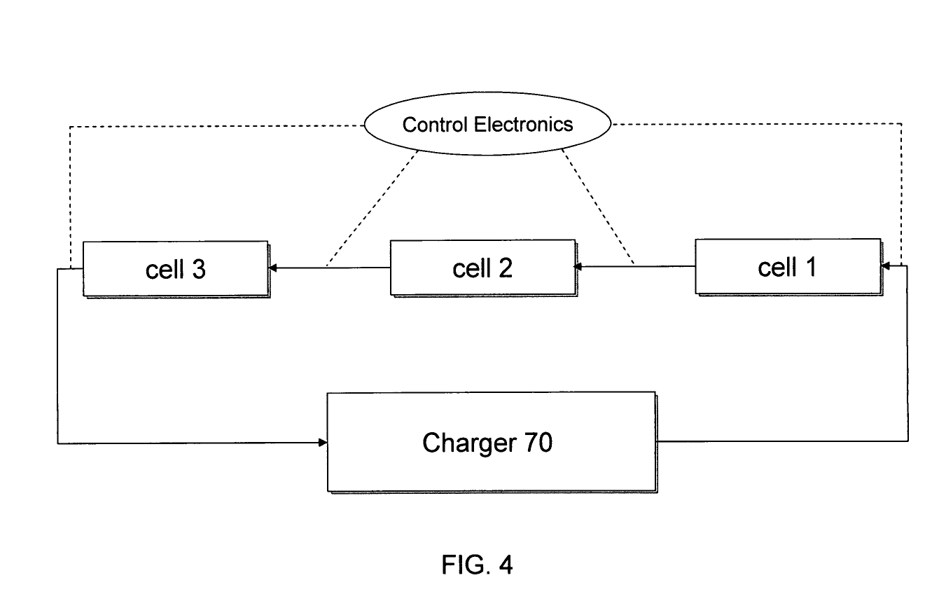

FIG. 4 is a schematic circuitry of the invention, showing how individual cells or batteries (e.g., battery 10 of FIG. 1 or battery 50 of FIG. 3) are arranged together in a battery pack. Charger 70 is employed to charge cells 1, 2 and 3.

Generally when a battery is in an overcharge abuse condition, a CID, such as CID 28, activates after the cell internal pressure reaches the pre-designed activating pressure. For example, in CID 28, second conductive component 32 separates from (e.g., deforms away or is detached from) first conductive component 30 when gauge pressure inside the battery is greater than a predetermined value, for example, between about 4 kg/cm² and about 15 kg/cm², whereby a current flow between second electrode 14 and battery can 21 (at least a portion of which is at least a component of a second terminal, or is electrically connected to the second terminal) is interrupted. Thus, after the CID activation, the electrical connection between the outside terminal and the inside electrode generally is interrupted. However, even after the CID activation, current can still flow through the cell, particularly when the cell is still connected to a charger (e.g., charger 70 of FIG. 4) that has been charging the cell. Such current flow through the cell even after the CID activation may be caused by potential electrochemical communication between, for example, cell casing 22 or lid 24 (at least a portion of which is at least a component of a second terminal, or is electrically connected to the second terminal) and first electrode 12 via electrolytes of the battery. Such current flow can cause decomposition of the electrolytes, which in turn contribute to continuous increase of the internal cell pressure even after the CID activation.

As an additional safety measure, in addition to a CID (e.g., CID 28), insulation that interrupts potential electrochemical communication between a first electrode (e.g., first electrode 12) and a second terminal (e.g., lid 24) or between a second electrode (e.g., second electrode 14) and a first terminal (e.g., component 26 of FIG. 1 or component 58 of FIG. 3) is employed in the invention. The insulation interrupts potential electrochemical communication between the first electrode and the second terminal or between the second electrode and the first terminal when under a charging or overcharging condition (e.g., see FIG. 4) and when the electrical communication between the first and second conductive components of the current interrupt device is interrupted to thereby interrupt the electrical communication between the first terminal and the first electrode or between the second terminal and the second electrode.

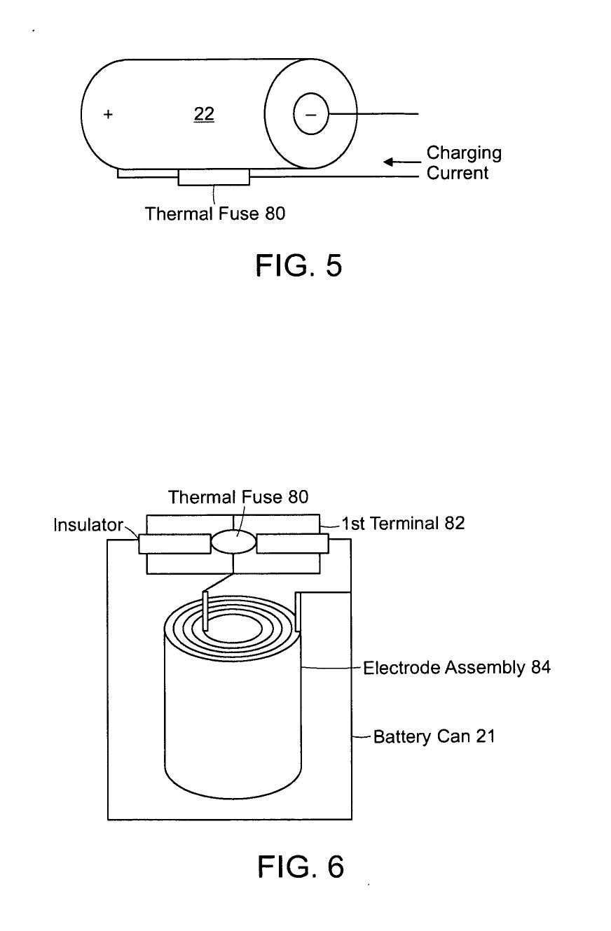

In one embodiment, the insulation is electrical insulation that interrupts current flow from a charger (e.g., charger 70 of FIG. 4) that charges the battery to either the first terminal or the second terminal. In one specific embodiment, the electrical insulation is a thermal fuse known in the art. As shown in FIG. 5, thermal fuse 80 can be at or over a portion of the outer surface of cell casing 22 holding electrode assembly 84. Alternatively, as shown in FIG. 6, thermal fuse 80 can be at one of the terminals that receives the current flow from charger 70 (not shown in FIG. 6).

In another embodiment, the insulation is a non-porous, non-conductive barrier between an electrode assembly (e.g., jelly roll) (which includes a first electrode (e.g., first electrode 12), a second electrode (e.g., second electrode 14) and electrolytes), and a cell casing (e.g., cell casing 22) that holds the electrode assembly. As used herein, the term “non-porous” means less porous than a conventional separator used in the battery industry, for example at least by about 5%, about 10%, about 30% or about 50%. In a specific embodiment, a “non-porous” barrier employed in the invention essentially blocks ionic transport (e.g., Li⁺), in contrast to the separator which allows ionic transport between positive and negative electrodes. As used herein, the term “non-conductive” means essentially blocking electronic conductivity. A “non-porous,” “non-conductive” barrier employed in the invention can essentially block ionic (e.g., Li⁺) and electronic transports. Examples of non-porous, non-conductive barriers that can be employed in the invention includes non-porous, non-conductive coatings, tapes, wraps, sleeves and bags.

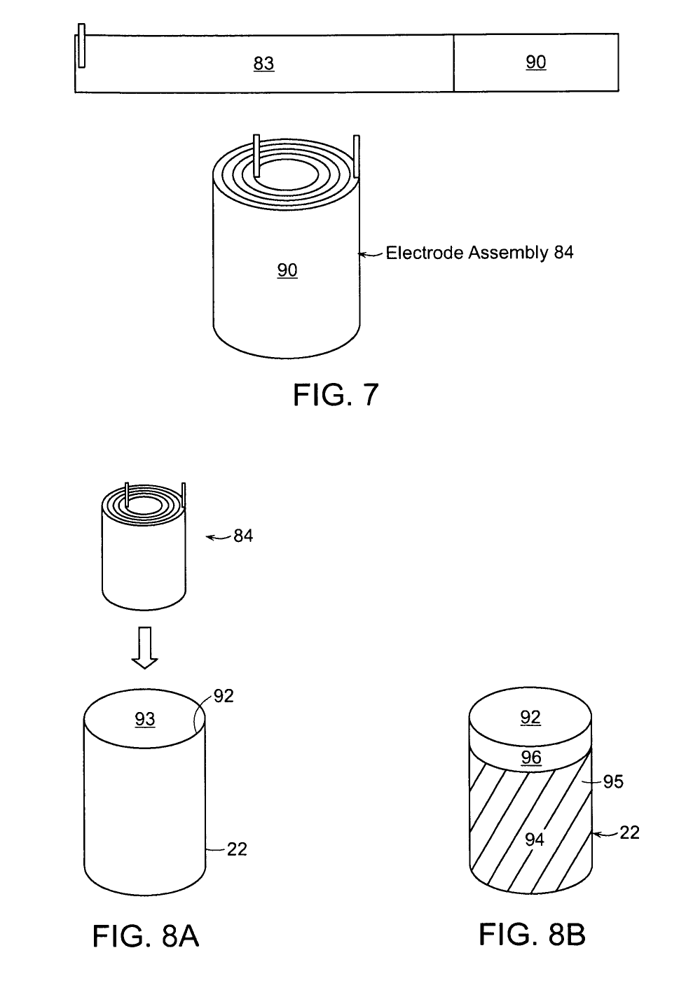

In one specific embodiment, a non-porous, non-conductive wrap or tape is employed in the invention. FIG. 7 shows one specific embodiment of such non-porous, non-conductive wrap or tape 90 between electrode assembly 84 and cell casing 22 (not shown in FIG. 7). In FIG. 7, non-porous, non-conductive wrap or tape 90 is disposed at the end of active material 83 that includes negative and positive electrodes and a separator. Active material 83 is spirally wound to produce electrode assembly 84, such as a “jelly roll” generally known in the art. Non-porous, non-conductive wrap or tape 90 extends from the end of electrode assembly 84 and wraps the outer wall of electrode assembly, providing a non-porous, non-conductive barrier between electrode assembly 84 (e.g., jelly roll) and cell casing 22 (not shown in FIG. 7).

In yet another specific embodiment, the insulation is a non-porous, non-conductive coating. As shown in FIG. 8A, non-porous, non-conductive coating 92 coats at least a portion of interior surface 93 of cell casing 22 (e.g., forming an anodized cell casing). In a more specific embodiment, non-porous, non-conductive coating 92 coats essentially entire interior surface 93 of cell casing 22. As used herein, the phrase “essentially entire interior surface” means at least about 90% of the total interior surface 93. Any suitable, non-porous, non-conductive coating known in the art can be employed in the invention. Suitable examples include Al₂O₃ and/or SiO₂ coatings. A typical example includes Al₂O₃. The non-porous, non-conductive coating can be made by any suitable method known in the art, for example, by chemical vapor deposition, sputtering, etc. The non-porous, non-conductive coating typically has a thickness in a range of between about 5 microns and about 50 microns, such as between about 5 microns and about 20 microns, or between about 5 microns and about 15 microns (e.g., about 10 microns).

Optionally, non-porous, non-conductive coating 92 can further coat at least a portion of the exterior surface of cell casing 22. In one specific example, as shown in FIG. 8B, coated portion 94 of exterior surface 95 of cell casing 22 is other than portion 96 of exterior surface 95 of cell casing 22 that is in contact with lid 24. In a specific embodiment, coated portion 94 of exterior surface 95 of cell casing 22 is other than the edge area of cell casing 22, to which lid 24 will be attached by, for example, welding. In a further specific embodiment, cell casing 22 is coated with non-porous, non-conductive coating 92 (e.g., Al₂O₃ coating) during its formation processes, e.g., at a pre-formed cell casing stage prior to final cell casing 22. In another further specific embodiment, the edge of the pre-formed cell casing that is coated with non-porous, non-conductive coating 92 (e.g., Al₂O₃ coating) is freshly cut at a final stage of formation of cell casing 22, generating an edge that is not coated with non-conductive coating 92. Alternatively, a mask known in the art can be employed to, for example, generate such a selective coating.

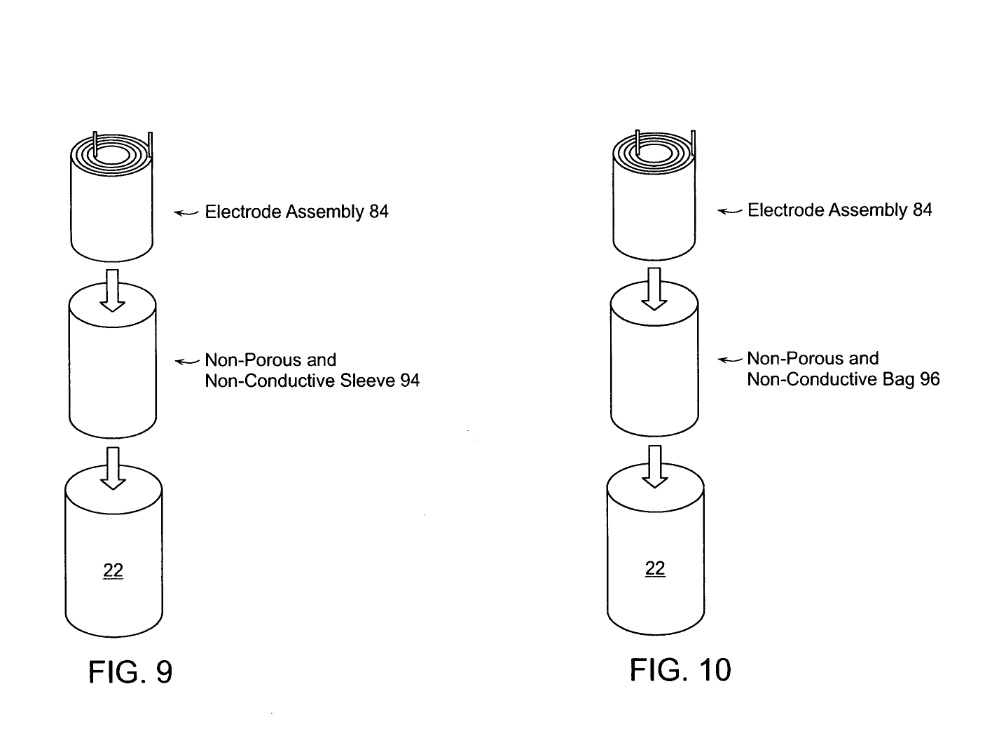

In yet another specific embodiment, a non-porous, non-conductive sleeve or bag is employed in the invention. FIG. 9 shows non-porous, non-conductive sleeve 94 to provide insulation between electrode assembly 84 and cell casing 22. FIG. 10 shows non-porous, non-conductive bag 96 to provide insulation between electrode assembly 84 and cell casing 22.

Any suitable non-porous, non-conductive material known in the art can be employed in the invention for the non-porous, non-conductive barrier, such as 90, 94 and 96. Common specific examples of suitable non-porous, non-conductive materials include polypropylenes.

Referring back to FIGS. 1-3, the term “feed-through” includes any material or device that connects electrode 12, within the internal space defined by cell casing 22 and lid 24, with a component of the battery external to that defined internal space. In one specific embodiment, feed-through device 16 or 52 extends through a pass-through hole defined by lid 24. Feed-through device 16 or 52 also can pass through lid 24 without deformation, such as bending, twisting and/or folding, and can increase cell capacity. Any other suitable means known in the art can also be used in the invention to connect electrode 12 with a component of the battery external to battery can 21, e.g., a terminal of the battery. Generally, feed-through devices 16 and 52 are electrically insulated from battery can 21, for example, lid 24, for example, by an insulating gasket (not shown in FIGS. 1-2B, insulator 56 of FIG. 3). The insulating gasket is formed of a suitable insulating material, such as polypropylene, polyvinylfluoride (PVF), etc. Components 18, 20 and 26 of feed-through device 16, and components 54 and 58 of feed-through device 52 can be made of any suitable conductive material known in the art, for example, nickel.

Referring back to FIGS. 1 and 3, in a specific embodiment, when first conductive component 30 separates from second conductive component 32, no rupture occurs in first conductive component 30 so that gas inside battery 10 or 50 does not go out through first conductive component 30. The gas can exit battery 10 or 50 through one or more venting means 56 (e.g., at cell wall or the bottom part of cell casing 22, or first conductive component 30), when the internal pressure keeps increasing and reaches a predetermined value for activation of venting means 56. In some embodiments, the predetermined gauge pressure value for activation of venting means 56 (e.g., between about 10 kg/cm² and about 20 kg/cm²) is higher than that for activation of CID 28 (e.g., between about 5 kg/cm² and about 10 kg/cm²). This feature helps prevent premature gas leakage, which can damage neighboring batteries (or cells) which are operating normally. So, when one of a plurality of cells in the battery packs of the invention is damaged, the other healthy cells are not damaged. It is noted that gauge pressure values or sub-ranges suitable for the activation of CID 28 and those for activation of venting means 56 are selected from among the predetermined gauge pressure ranges such that there is no overlap between the selected pressure values or sub-ranges. Preferably, the values or ranges of gauge pressure for the activation of CID 28 and those for the activation of venting means 56 differ by at least about 2 kg/cm² pressure difference, more preferably by at least about 4 kg/cm², even more preferably by at least about 6 kg/cm², such as by about 7 kg/cm².

First conductive component 30, second conductive component 32 and end component 40 of CID 28 can be made of any suitable conductive material known in the art for a battery. Examples of suitable materials include aluminum, nickel and copper, preferably aluminum. In one specific embodiment, battery can 21 (e.g., cell casing 22 and lid 24), first conductive component 30 and second conductive component 32 are made of substantially the same metals. As used herein, the term “substantially same metals” means metals that have substantially the same chemical and electrochemical stability at a given voltage, e.g., the operation voltage of a battery. More preferably, battery can 21, first conductive component 30 and second conductive component 32 are made of the same metal, such as aluminum (e.g., Aluminum 3003 series, such as Aluminum 3003H-14 series and/or Aluminum 3003H-0 series).

CID 28 can be made by any suitable method known in the art, for example, in WO 2008/002487 and U.S. Provisional Application No. 60/936,825 (the entire teachings of both of which are incorporated herein by reference). Attachment of CID 28 to battery can 21 can be done by any suitable means known in the art. In a specific embodiment, CID 28 is attached to battery can 21 via welding, and more preferably by welding first conductive component 30 onto end component 40 (or lid 24 itself).

Cell casing 22 can be made of any suitable electrically-conductive material which is essentially stable electrically and chemically at a given voltage of batteries, such as the lithium-ion batteries of the invention. Examples of suitable materials of cell casing 22 include metallic materials, such as aluminum, nickel, copper, steel, nickel-plated iron, stainless steel and combinations thereof. In a specific embodiment, cell casing 22 is of, or includes, aluminum.

Examples of suitable materials of lid 24 are the same as those listed for cell casing 22. In a specific embodiment, lid 24 is made of the same material as cell casing 22. In another specific embodiment, both cell casing 22 and lid 24 are formed of, or include, aluminum.

Lid 24 can hermetically seal cell casing 22 by any suitable method known in the art (e.g., welding, crimping, etc). In a specific embodiment, lid 24 and cell casing 22 are welded to each other. In another specific embodiment, the weld connecting lid 24 and cell casing 22 ruptures when an gauge pressure between lid 24 and cell casing 22 is greater than about 20 kg/cm².

Referring back to FIGS. 1 and 3, in some preferred embodiments, cell casing 22 includes at least one venting means 56 as a means for venting interior gaseous species when necessary (e.g., when an internal gauge pressure is in a range of between about 10 kg/cm² and about 20 kg/cm², such as between about 12 kg/cm² and about 20 kg/cm² or between about 10 kg/cm² and about 18 kg/cm²). It is to be understood that any suitable type of venting means can be employed as long as the means provide hermetic sealing in normal battery operation conditions. Various suitable examples of venting means are described in U.S. Provisional Application No. 60/717,898, filed on Sep. 16, 2005, the entire teachings of which are incorporated herein by reference.

Specific examples of venting means include vent scores. As used herein, the term “score” means partial incision of section(s) of a cell casing, such as cell casing 104, that is designed to allow the cell pressure and any internal cell components to be released at a defined internal pressure. Preferably, venting means 112 is a vent score, more preferably, vent score that is directionally positioned away from a user/or neighboring cells. More than one vent score can be employed in the invention. In some embodiments, patterned vent scores can be employed. The vent scores can be parallel, perpendicular, diagonal to a major stretching (or drawing) direction of the cell casing material during creation of the shape of the cell casing. Consideration is also given to vent score properties, such as depth, shape and length (size).

The batteries of the invention can further include a positive thermal coefficient layer (PTC) in electrical communication with either the first terminal or the second terminal, preferably in electrical communication with the first terminal. Suitable PTC materials are those known in the art. Generally, suitable PTC materials are those that, when exposed to an electrical current in excess of a design threshold, its electrical conductivity decreases with increasing temperature by several orders of magnitude (e.g., 10⁴ to 10⁶ or more). Once the electrical current is reduced below a suitable threshold, in general, the PTC material substantially returns to the initial electrical resistivity. In one suitable embodiment, the PTC material includes small quantities of semiconductor material in a polycrystalline ceramic, or a slice of plastic or polymer with carbon grains embedded in it. When the temperature of the PTC material reaches a critical point, the semiconductor material or the plastic or polymer with embedded carbon grains forms a barrier to the flow of electricity and causes electrical resistance to increase precipitously. The temperature at which electrical resistivity precipitously increases can be varied by adjusting the composition of the PTC material, as is known in the art. An “operating temperature” of the PTC material is a temperature at which the PTC exhibits an electrical resistivity about half way between its highest and lowest electrical resistance. Preferably, the operating temperature of the PTC layer employed in the invention is between about 70° Celsius and about 150° Celsius.

Examples of specific PTC materials include polycrystalline ceramics containing small quantities of barium titanate (BaTiO₃), and polyolefins including carbon grains embedded therein. Examples of commercially available PTC laminates that include a PTC layer sandwiched between two conducting metal layers include LTP and LR4 series manufactured by Raychem Co. Generally, the PTC layer has a thickness in a range of about 50 μm and about 300 μm.

Preferably, the PTC layer includes an electrically conductive surface, the total area of which is at least about 25% or at least about 50% (e.g., about 48% or about 56%) of the total surface area of lid 24 or the bottom of battery 10 or 50. The total surface area of the electrically conductive surface of the PTC layer can be at least about 56% of the total surface area of lid 24 or the bottom of battery 10 or 50. Up to 100% of the total surface area of lid 24 of battery 10 or 50 can occupied by the electrically conductive surface of the PTC layer. Alternatively, the whole, or part, of the bottom of battery 10 or 50 can be occupied by the electrically conductive surface of the PTC layer.

The PTC layer can be positioned externally to the battery can, for example, over a lid (e.g., lid 24 of FIGS. 1 and 3) of the battery can.

In one specific embodiment, the PTC layer is between a first conductive layer and a second conductive layer and at least a portion of the second conductive layer is at least a component of the first terminal, or is electrically connected to the first terminal. In another specific embodiment, the first conductive layer is connected to the feed-through device. Suitable examples of such a PTC layer sandwiched between the first and second conductive layers are described in WO 2007/149102, the entire teachings of which are incorporated herein by reference.

In some specific embodiments, a battery of the invention includes battery can 21 that includes cell casing 22 and lid 24, at least one CID, such as CID 28 described above, in electrical communication with either of the first or second electrodes of the battery, and at least one venting means 56 on cell casing 22. As described above, battery can 21 is electrically insulated from the first terminal that is in electrical communication with the first electrode of the battery. At least a portion of battery can 21 is at least a component of the second terminal that is in electrical communication with the second electrode of the battery. Lid 24 is welded on cell casing 22 such that the welded lid is detached from cell casing 22 at an internal gauge pressure greater than about 20 kg/cm². The CID includes a first conductive component (e.g., first conductive component 30) and a second conductive component (e.g., second conductive component 32) in electrical communication with each other, preferably by a weld. This electrical communication is interrupted at an internal gauge pressure between about 4 kg/cm² and about 10 kg/cm², (e.g., between about 5 kg/cm² and about 9 kg/cm² or between about 7 kg/cm² and about 9 kg/cm²). For example, the first and second conductive components are welded, e.g., laser welded, to each other such that the weld ruptures at the predetermined gauge pressure. At least one venting means 56 is formed to vent interior gaseous species when an internal gauge pressure in a range of between about 10 kg/cm² and about 20 kg/cm² or between about 12 kg/cm² and about 20 kg/cm². As described above, it is noted that gauge pressure values or sub-ranges suitable for the activation of CID 28 and those for activation of venting means 56 are selected from among the predetermined gauge pressure ranges such that there is no overlap between the selected pressure values or sub-ranges. Typically, the values or ranges of gauge pressure for the activation of CID 28 and those for the activation of venting means 56 differ by at least about 2 kg/cm² pressure difference, more typically by at least about 4 kg/cm², even more preferably by at least about 6 kg/cm², such as by about 7 kg/cm². Also, it is noted that gauge pressure values or sub-ranges suitable for the rupture of the welded lid 24 from cell casing 22 and those for activation of venting means 56 are selected from among the predetermined gauge pressure ranges such that there is no overlap between the selected pressure values or sub-ranges.

Generally, the battery of the invention is rechargeable. In a specific embodiment, the battery of the invention is a rechargeable lithium-ion battery.

In a certain embodiment, the battery of the invention, such as a lithium-ion battery, has an internal gauge pressure of less than or equal to about 2 kg/cm² under a normal working condition. For such a battery of the invention, the active electrode materials can be first activated prior to hermetical sealing of the battery can.

The battery (or cell) of the invention can be cylindrical (e.g., 26650, 18650, or 14500 configuration) or prismatic (stacked or wound, e.g., 183665 or 103450 configuration). Preferably, they are prismatic, and, more preferably, of a prismatic shape that is oblong. Although the present invention can use all types of prismatic cell casings, an oblong cell casing is preferred partly due to the two features described below.

The available internal volume of an oblong shape, such as the 183665 form factor, is larger than the volume of two 18650 cells, when comparing stacks of the same external volume. When assembled into a battery pack, the oblong cell fully utilizes more of the space that is occupied by the battery pack. This enables novel design changes to the internal cell components that can increase key performance features without sacrificing cell capacity relative to that found in the industry today. Due to the larger available volume, one can elect to use thinner electrodes, which have relatively higher cycle life and a higher rate capability. Furthermore, an oblong can has larger flexibility. For instance, an oblong shape can flex more at the waist point compared to a cylindrically shaped can, which allows less flexibility as stack pressure increases upon charging. The increased flexibility decreases mechanical fatigue on the electrodes, which, in turn, causes higher cycle life. Also, clogging of pores of a separator in batteries can be improved by employing a relatively low stack pressure.

A particularly desired feature, allowing relatively higher safety, is available for the oblong shaped battery compared to the prismatic battery. The oblong shape provides a snug fit to the jelly roll, which minimizes the amount of electrolyte necessary for the battery. The relatively low amount of electrolyte results in less available reactive material during a misuse scenario and hence higher safety. In addition, the cost is lower due to employment of a lower amount of electrolyte. In the case of a prismatic can with a stacked electrode structure, whose cross-section is in a rectangular shape, essentially full volume utilization is possible without unnecessary electrolyte, but this type of can design is more difficult and hence more costly from a manufacturing point-of-view.

Referring back to FIG. 4, in some embodiments of the invention, a plurality of lithium-ion batteries of the invention (e.g., 2 to 5 cells) can be connected in a battery pack, wherein each of the batteries (cells) is connected with each other in series, parallel, or in series and parallel. In some battery packs of the invention, there are no parallel connections between the batteries.

Preferably, at least one cell has a prismatic shaped cell casing, and more preferably, an oblong shaped cell casing, as shown in FIG. 1. Preferably, the capacity of the cells in the battery pack is typically equal to or greater than about 3.0 Ah, more preferably equal to or greater than about 4.0 Ah. The internal impedance of the cells is preferably less than about 50 milli-ohms, and more preferably less than 30 milli-ohms.

The present invention also includes methods of producing a battery, such as a rechargeable lithium-ion battery, as described above. The methods include forming insulation as a component of the battery. Features, including specific features of the insulation are as described above.

Positive and negative electrodes, and electrolytes for the lithium-ion batteries (or cells) of the invention can be formed by suitable methods known in the art.

Examples of suitable negative-active materials for the negative electrodes include any material allowing lithium to be doped or undoped in or from the material. Examples of such materials include carbonaceous materials, for example, non-graphitic carbon, artificial carbon, artificial graphite, natural graphite, pyrolytic carbons, cokes such as pitch coke, needle coke, petroleum coke, graphite, vitreous carbons, or a heat-treated organic polymer compounds obtained by carbonizing phenol resins, furan resins, or similar, carbon fibers, and activated carbon. Further, metallic lithium, lithium alloys, and an alloy or compound thereof are usable as the negative active materials. In particular, the metal element or semiconductor element allowed to form an alloy or compound with lithium may be a group IV metal element or semiconductor element, such as, but not limited to, silicon or tin. Oxides allowing lithium to be doped or undoped in or out from the oxide at a relatively basic potential, such as iron oxide, ruthenium oxide, molybdenum oxide, tungsten oxide, titanium oxide, and tin oxide, and nitrides, similarly, are usable as the negative-active materials. In a specific embodiment, amorphous tin optionally doped with a transition metal, such as cobalt or iron/nickel, is employed in the invention.

Suitable positive-active materials for the positive electrodes include any material known in the art, for example, lithium nickelates, lithium cobaltates, olivine-type compounds and manganate spinel compounds, and mixtures thereof. Various examples of suitable positive-active materials can be found in WO 2006/071972, WO 2008/002486, and U.S. Provisional Application No. 61/125,285, filed on Apr. 24, 2008, the entire teachings of all of which are incorporated herein by reference.

In one specific embodiment, the positive-active materials for the positive electrodes of the invention include a lithium cobaltate, such as Li₍₁₊ₓ₈₎CoO_{z8}. More specifically, a mixture of about 60-90 wt % (e.g. about 80 wt %) of a lithium cobaltate, such as Li₍₁₊ₓ₈₎CoO_{z8}, and about 40-10 wt % (e.g., about 20 wt %) of a manganate spinel, such as Li₍₁₊ₓ₁₎Mn₂O_{z1}, is employed for the invention. The value x1 is equal to or greater than zero and equal to or less than 0.3 (e.g., 0.05≦x1≦0.2 or 0.05≦x1≦0.15). The value z1 is equal to or greater than 3.9 and equal to or greater than 4.2. The value x8 is equal to or greater than zero and equal to or less than 0.2. The value z8 is equal to or greater than 1.9 and equal to or greater than 2.1.

In another specific embodiment, the positive-active materials for the invention include a mixture that includes a lithium cobaltate, such as Li₍₁₊ₓ₈₎CoO_{z8}, and a manganate spinel represented by an empirical formula of Li₍₁₊ₓ₁₎(Mn_{1-y1}A′_{y2})₂₋ₓ₂O_{z1}. The values x1 and x2 are each independently equal to or greater than 0.01 and equal to or less than 0.3. The values y1 and y2 are each independently equal to or greater than 0.0 and equal to or less than 0.3. The value z1 is equal to or greater than 3.9 and equal to or less than 4.2. A′ is at least one member of the group consisting of magnesium, aluminum, cobalt, nickel and chromium. More specifically, the lithium cobaltate and the manganate spinel are in a weight ratio of lithium cobaltate:manganate spinel between about 0.95:0.05 and about 0.6:0.4. Alternatively, the lithium cobaltate and the manganate spinel are in a weight ratio of lithium cobaltate:manganate spinel between about 0.90:0.10 and about 0.75:0.25.

In yet another specific embodiment, the positive-active materials for the invention include a mixture that includes 100% of a lithium cobaltate, such as Li₍₁₊ₓ₈₎CoO_{z8}.

In yet another specific embodiment, the positive-active materials for the invention include at least one lithium oxide selected from the group consisting of: a) a lithium cobaltate; b) a lithium nickelate; c) a manganate spinel represented by an empirical formula of Li₍₁₊ₓ₁₎(Mn_{1-y1}A′_{y2})₂₋ₓ₂O_{z1}; d) a manganate spinel represented by an empirical formula of Li₍₁₊ₓ₁₎Mn₂O_{z1} or Li₁₊ₓ₉Mn_{2-y9}O₄; and e) an olivine compound represented by an empirical formula of Li₍₁₋ₓ₁₀₎A″ₓ₁₀MPO₄. The values of x1, z1, x9 and y9 are as described above. The value, x2, is equal to or greater than 0.01 and equal to or less than 0.3. The values of y1 and y2 are each independently equal to or greater than 0.0 and equal to or less than 0.3. A′ is at least one member of the group consisting of magnesium, aluminum, cobalt, nickel and chromium. The value, x10, is equal to or greater than 0.05 and equal to or less than 0.2, or the value, x10, is equal to or greater than 0.0 and equal to or less than 0.1. M is at least one member of the group consisting of iron, manganese, cobalt and magnesium. A″ is at least one member of the group consisting of sodium, magnesium, calcium, potassium, nickel and niobium.

A lithium nickelate that can be used in the invention includes at least one modifier of either the Li atom or Ni atom, or both. As used herein, a “modifier” means a substituent atom that occupies a site of the Li atom or Ni atom, or both, in a crystal structure of LiNiO₂. In one embodiment, the lithium nickelate includes only a modifier of, or substituent for, Li atoms (“Li modifier”). In another embodiment, the lithium nickelate includes only a modifier of, or substituent for, Ni atoms (“Ni modifier”). In yet another embodiment, the lithium nickelate includes both the Li and Ni modifiers. Examples of Li modifiers include barium (Ba), magnesium (Mg), calcium (Ca) and strontium (Sr). Examples of Ni modifiers include those modifiers for Li and, in addition, aluminum (Al), manganese (Mn) and boron (B). Other examples of Ni modifiers include cobalt (Co) and titanium (Ti). Preferably, the lithium nickelate is coated with LiCoO₂. The coating can be, for example, a gradient coating or a spot-wise coating.

One particular type of a lithium nickelate that can be used in the invention is represented by an empirical formula of Liₓ₃Ni_{1-z3}M′_{z3}O₂ where 0.05<x3<1.2 and 0<z3<0.5, and M′ is one or more elements selected from a group consisting of Co, Mn, Al, B, Ti, Mg, Ca and Sr. Preferably, M′ is one or more elements selected from a group consisting of Mn, Al, B, Ti, Mg, Ca and Sr.

Another particular type of a lithium nickelate that can be used in the invention is represented by an empirical formula of Liₓ₄A*ₓ₅Ni_{(1-y4-z4)}Co_{y4}Q_{z4}Oₐ where x4 is equal to or greater than about 0.1 and equal to or less than about 1.3; x5 is equal to or greater than 0.0 and equal to or less than about 0.2; y4 is equal to or greater than 0.0 and equal to or less than about 0.2; z4 is equal to or greater than 0.0 and equal to or less than about 0.2; a is greater than about 1.5 and less than about 2.1; A* is at least one member of the group consisting of barium (Ba), magnesium (Mg) and calcium (Ca); and Q is at least one member of the group consisting of aluminum (Al), manganese (Mn) and boron (B). Preferably, y4 is greater than zero. In one preferred embodiment, x5 is equal to zero, and z4 is greater than 0.0 and equal to or less than about 0.2. In another embodiment, z4 is equal to zero, and x5 is greater than 0.0 and equal to or less than about 0.2. In yet another embodiment, x5 and z4 are each independently greater than 0.0 and equal to or less than about 0.2. In yet another embodiment, x5, y4 and z4 are each independently greater than 0.0 and equal to or less than about 0.2. Various examples of lithium nickelates where x5, y4 and z4 are each independently greater than 0.0 and equal to or less than about 0.2, can be found in U.S. Pat. Nos. 6,855,461 and 6,921,609 (the entire teachings of which are incorporated herein by reference).

A specific example of the lithium nickelate is LiNi_{0.8}Co_{0.15}Al_{0.05}O₂. A preferred specific example is LiCoO₂-coated LiNi_{0.8}CO_{0.15}Al_{0.05}O₂. In a spot-wise coated cathode, LiCoO₂ doe not fully coat the nickelate core particle. The composition of LiNi_{0.8}Co_{0.15}Al_{0.05}O₂ coated with LiCoO₂ can naturally deviate slightly in composition from the 0.8:0.15:0.05 weight ratio between Ni:Co:Al. The deviation can range about 10-15% for the Ni, 5-10% for Co and 2-4% for Al. Another specific example of the lithium nickelate is Li_{0.97}Mg_{0.03}Ni_{0.9}Co_{0.1}O₂. A preferred specific example is LiCoO₂-coated Li_{0.97}Mg_{0.03}Ni_{0.9}Co_{0.1}O₂. The composition of Li_{0.97}Mg_{0.03}Ni_{0.9}Co_{0.1}O₂ coated with LiCoO₂ can deviate slightly in composition from the 0.03:0.9:0.1 weight ratio between Mg:Ni:Co. The deviation can range about 2-4% for Mg, 10-15% for Ni and 5-10% for Co. Another preferred nickelate that can be used in the present invention is Li(Ni_{1/3}Co_{1/3}Mn_{1/3})O₂, also called “333-type nickelate.” This 333-type nickelate optionally can be coated with LiCoO₂, as described above.

Suitable examples of lithium cobaltates that can be used in the invention include Li₁₊ₓ₈CoO₂ that is modified by at least one of Li or Co atoms. Examples of the Li modifiers are as described above for Li of lithium nickelates. Examples of the Co modifiers include the modifiers for Li and aluminum (Al), manganese (Mn) and boron (B). Other examples include nickel (Ni) and titanium (Ti) and, in particular, lithium cobaltates represented by an empirical formula of Liₓ₆M′_{y6}Co_{(1-z6)}M″_{z6}O₂, where x6 is greater than 0.05 and less than 1.2; y6 is greater than 0 and less than 0.1, z6 is equal to or greater than 0 and less than 0.5; M′ is at least one member of magnesium (Mg) and sodium (Na) and M″ is at least one member of the group consisting of manganese (Mn), aluminum (Al), boron (B), titanium (Ti), magnesium (Mg), calcium (Ca) and strontium (Sr), can be used in the invention. Another example of a lithium cobaltate that can be used in the invention is unmodified Li₁₊₈CoO₂, such as LiCoO₂. In one specific embodiment, the lithium cobaltate (e.g., LiCoO₂) doped with Mg and/or coated with a refractive oxide or phosphate, such as ZrO₂ or Al(PO₄).

It is particularly preferred that lithium oxide compounds employed have a spherical-like morphology, since it is believed that this improves packing and other production-related characteristics.

Preferably, a crystal structure of each of the lithium cobaltate and lithium nickelate is independently a R-3m type space group (rhombohedral, including distorted rhombohedral). Alternatively, a crystal structure of the lithium nickelate can be in a monoclinic space group (e.g., P2/m or C2/m). In a R-3m type space group, the lithium ion occupies the “3a” site (x=0, y=0 and z=0) and the transition metal ion (i.e., Ni in a lithium nickelate and Co in a lithium cobaltate) occupies the “3b” site (x=0, y=0, z=0.5). Oxygen is located in the “6a” site (x=0, y=0, z=0, where z0 varies depending upon the nature of the metal ions, including modifier(s) thereof).

Examples of olivine compounds that are suitable for use in the invention are generally represented by a general formula Li₁₋ₓ₂A″ₓ₂MPO₄, where x2 is equal to or greater than 0.05, or x2 is equal to or greater than 0.0 and equal to or greater than 0.1; M is one or more elements selected from a group consisting of Fe, Mn, Co, or Mg; and A″ is selected from a group consisting of Na, Mg, Ca, K, Ni, Nb. Preferably, M is Fe or Mn. More preferably, LiFePO₄ or LiMnPO₄, or both are used in the invention. In a preferred embodiment, the olivine compounds are coated with a material having relatively high electrical conductivity, such as carbon. In a more preferred embodiment, carbon-coated LiFePO₄ or carbon-coated LiMnPO₄ is employed in the invention. Various examples of olivine compounds where M is Fe or Mn can be found in U.S. Pat. No. 5,910,382 (the entire teachings of which are incorporated herein by reference).

The olivine compounds typically have a small change in crystal structure upon charging/discharging, which generally makes the olivine compounds superior in terms of cycle characteristics. Also, safety is generally high, even when a battery is exposed to a high temperature environment. Another advantage of olivine compounds (e.g., LiFePO₄ and LiMnPO₄) is their relatively low cost.

Manganate spinel compounds have a manganese base, such as LiMn₂O₄. While the manganate spinel compounds typically have relatively low specific capacity (e.g., in a range of about 110 to 115 mAh/g), they have relatively high power delivery when formulated into electrodes and typically are safe in terms of chemical reactivity at higher temperatures. Another advantage of the manganate spinel compounds is their relatively low cost.

One type of manganate spinel compounds that can be used in the invention is represented by an empirical formula of Li₍₁₊ₓ₁₎(Mn_{1-y1}A′_{y2})₂₋ₓ₂O_{z1}, where A′ is one or more of Mg, Al, Co, Ni and Cr; x1 and x2 are each independently equal to or greater than 0.01 and equal to or less than 0.3; y1 and y2 are each independently equal to or greater than 0.0 and equal to or less than 0.3; z1 is equal to or greater than 3.9 and equal to or less than 4.1. Preferably, A′ includes a M³⁺ ion, such as Al³⁺, Co³⁺, Ni³⁺ and Cr³⁺, more preferably Al³⁺. The manganate spinel compounds of Li₍₁₊ₓ₁₎(Mn_{1-y1}A′_{y2})₂₋ₓ₂O_{z1} can have enhanced cyclability and power compared to those of LiMn₂O₄. Another type of manganate spinel compounds that can be used in the invention is represented by an empirical formula of Li₍₁₊ₓ₁₎Mn₂O_{z1}, where x1 and z1 are each independently the same as described above. Alternatively, the manganate spinel for the invention includes a compound represented by an empirical formula of Li₁₊ₓ₉Mn_{2-y9}O_{z9} where x9 and y9 are each independently equal to or greater than 0.0 and equal to or less than 0.3 (e.g., 0.05≦x9, y9≦0.15); and z9 is equal to or greater than 3.9 and equal to or less than 4.2. Specific examples of the manganate spinel that can be used in the invention include LiMn_{1.9}Al_{0.1}O₄, Li₁₊ₓ₁Mn₂O₄, Li₁₊ₓ₇Mn_{2-y7}O₄, and their variations with Al and Mg modifiers. Various other examples of manganate spinel compounds of the type Li₍₁₊ₓ₁₎(Mn_{1-y1}A′_{y2})₂₋ₓ₂O_{z1} can be found in U.S. Pat. Nos. 4,366,215; 5,196,270; and 5,316,877 (the entire teachings of which are incorporated herein by reference).

It is noted that the suitable cathode materials described herein are characterized by empirical formulas that exist upon manufacture of lithium-ion batteries in which they are incorporated. It is understood that their specific compositions thereafter are subject to variation pursuant to their electrochemical reactions that occur during use (e.g., charging and discharging).

Examples of suitable non-aqueous electrolytes include a non-aqueous electrolytic solution prepared by dissolving an electrolyte salt in a non-aqueous solvent, a solid electrolyte (inorganic electrolyte or polymer electrolyte containing an electrolyte salt), and a solid or gel-like electrolyte prepared by mixing or dissolving an electrolyte in a polymer compound or the like.

The non-aqueous electrolytic solution is typically prepared by dissolving a salt in an organic solvent. The organic solvent can include any suitable type that has been generally used for batteries of this type. Examples of such organic solvents include propylene carbonate (PC), ethylene carbonate (EC), diethyl carbonate (DEC), dimethyl carbonate (DMC), 1,2-dimethoxyethane, 1,2-diethoxyethane, γ-butyrolactone, tetrahydrofuran, 2-methyl tetrahydrofuran, 1,3-dioxolane, 4-methyl-1,3-dioxolane, diethyl ether, sulfolane, methylsulfolane, acetonitrile, propionitrile, anisole, acetate, butyrate, propionate and the like. It is preferred to use cyclic carbonates such as propylene carbonate, or chain carbonates such as dimethyl carbonate and diethyl carbonate. These organic solvents can be used singly or in a combination of two types or more.

Additives or stabilizers may also be present in the electrolyte, such as VC (vinyl carbonate), VEC (vinyl ethylene carbonate), EA (ethylene acetate), TPP (triphenylphosphate), phosphazenes, biphenyl (BP), cyclohexylbenzene (CHB), 2,2-diphenylpropane (DP), lithium bis(oxalato)borate (LiBoB), ethylene sulfate (ES) and propylene sulfate. These additives are used as anode and cathode stabilizers, flame retardants or gas releasing agents, which may make a battery have higher performance in terms of formation, cycle efficiency, safety and life.

The solid electrolyte can include an inorganic electrolyte, a polymer electrolyte and the like insofar as the material has lithium-ion conductivity. The inorganic electrolyte can include, for example, lithium nitride, lithium iodide and the like. The polymer electrolyte is composed of an electrolyte salt and a polymer compound in which the electrolyte salt is dissolved. Examples of the polymer compounds used for the polymer electrolyte include ether-based polymers such as polyethylene oxide and cross-linked polyethylene oxide, polymethacrylate ester-based polymers, acrylate-based polymers and the like. These polymers may be used singly, or in the form of a mixture or a copolymer of two kinds or more.

A matrix of the gel electrolyte may be any polymer insofar as the polymer is gelated by absorbing the above-described non-aqueous electrolytic solution. Examples of the polymers used for the gel electrolyte include fluorocarbon polymers such as polyvinylidene fluoride (PVDF), polyvinylidene-co-hexafluoropropylene (PVDF-HFP) and the like.

Examples of the polymers used for the gel electrolyte also include polyacrylonitrile and a copolymer of polyacrylonitrile. Examples of monomers (vinyl based monomers) used for copolymerization include vinyl acetate, methyl methacrylate, butyl methacylate, methyl acrylate, butyl acrylate, itaconic acid, hydrogenated methyl acrylate, hydrogenated ethyl acrylate, acrylamide, vinyl chloride, vinylidene fluoride, and vinylidene chloride. Examples of the polymers used for the gel electrolyte further include acrylonitrile-butadiene copolymer rubber, acrylonitrile-butadiene-styrene copolymer resin, acrylonitrile-chlorinated polyethylene-propylenediene-styrene copolymer resin, acrylonitrile-vinyl chloride copolymer resin, acrylonitrile-methacylate resin, and acrylonitrile-acrylate copolymer resin.

Examples of the polymers used for the gel electrolyte include ether based polymers such as polyethylene oxide, copolymer of polyethylene oxide, and cross-linked polyethylene oxide. Examples of monomers used for copolymerization include polypropylene oxide, methyl methacrylate, butyl methacylate, methyl acrylate, butyl acrylate.

In particular, from the viewpoint of oxidation-reduction stability, a fluorocarbon polymer is preferably used for the matrix of the gel electrolyte.

The electrolyte salt used in the electrolyte may be any electrolyte salt suitable for batteries of this type. Examples of the electrolyte salts include LiClO₄, LiAsF₆, LiPF₆, LiBF₄, LiB(C₆H₅)₄, LiB(C₂O₄)₂, CH₃SO₃Li, CF₃SO₃Li, LiCl, LiBr and the like. Generally, a separator separates the positive electrode from the negative electrode of the batteries. The separator can include any film-like material having been generally used for forming separators of non-aqueous electrolyte secondary batteries of this type, for example, a microporous polymer film made from polypropylene, polyethylene, or a layered combination of the two. In addition, if a solid electrolyte or gel electrolyte is used as the electrolyte of the battery, the separator does not necessarily need to be provided. A microporous separator made of glass fiber or cellulose material can in certain cases also be used. Separator thickness is typically between about 9 and about 25 μm.

In some specific embodiments, the positive electrode of a battery (or cell) of the invention can be produced by mixing the cathode powders at a specific ratio. About 90 wt % of this blend is then mixed together with about 5 wt % of acetylene black as a conductive agent, and about 5 wt % of PVDF as a binder. The mix is dispersed in N-methyl-2-pyrrolidone (NMP) as a solvent, in order to prepare slurry. This slurry is then applied to both surfaces of an aluminum current collector foil, having a typical thickness of about 20 μm, and dried at about 100-150° C. The dried electrode is then calendared by a roll press, to obtain a compressed positive electrode. When LiCoO₂ is solely used as the positive electrode a mixture using about 94 wt % LiCoO₂, about 3% acetylene black, and about 3% PVDF is typically used. The negative electrode of a battery (or cell) of the invention can be prepared by mixing about 93 Wt % of graphite as a negative active material, about 3 wt % acetylene black, and about 4 wt % of PVDF as a binder. The negative mix is also dispersed in N-methyl-2-pyrrolidone as a solvent, in order to prepare the slurry. The negative mix slurry was uniformly applied on both surfaces of a strip-like copper negative current collector foil, having a typical thickness of about 10 μm. The dried electrode is then calendared by a roll press to obtain a dense negative electrode.

The negative and positive electrodes and a separator (e.g., about 25 μm thick) formed of, for example, a polyethylene film with micro pores, are generally laminated spirally wound to produce a spiral type electrode element.

In some embodiments, one or more positive lead strips, made of, e.g., aluminum, are attached to the positive current electrode, and then electrically connected to the positive terminal of the batteries of the invention. A negative lead, made of, e.g., nickel metal, connects the negative electrode, and then attached to a feed-through device. An electrolyte of for instance EC:DMC:DEC with 1M LiPF₆, is vacuum filled in the cell casing of a lithium-ion battery of the invention, where the cell casing has the spirally wound “jelly roll.”

### Incorporation by Reference

WO 2006/071972; WO 2007/011661; WO 2007/149102; WO 2008/002486; WO 2008/002487; U.S. Provisional Application No. 60/717,898, filed on Sep. 16, 2005; U.S. Provisional Application No. 60/936,825, filed on Jun. 22, 2007; U.S. Provisional Application No. 61/125,285, filed on Apr. 24, 2008; and U.S. Provisional Application No. 61/125,281, filed on Apr. 24, 2008, are all incorporated herein by reference in their entirety.

### EQUIVALENTS

While this invention has been particularly shown and described with references to example embodiments thereof, it will be understood by those skilled in the art that various changes in form and details may be made therein without departing from the scope of the invention encompassed by the appended claims.

1. A battery, comprising:
a) a cell casing;
b) a first terminal;
c) a second terminal in electrical communication with the cell casing and electrically insulated from the first terminal;
d) an electrode assembly in the cell casing, the electrode assembly including a first electrode in electrical communication with the first terminal, a second electrode in electrical communication with the second terminal, and an electrolyte between the first and second electrodes;
e) a current interrupt device in electrical communication with the first terminal and the first electrode, or with the second terminal and the second electrode, the current interrupt device including a first conductive component and a second conductive component in electrical communication with each other, wherein the electrical communication between the first and second conductive components is interrupted when a gauge pressure between the two components is in a range of between about 4 kg/cm² and about 15 kg/cm²; and
f) insulation that interrupts potential electrochemical communication between the first electrode and the second terminal or between the second electrode and the first terminal, when under a charging or overcharging condition and when the electrical communication between the first and second conductive components of the current interrupt device has been interrupted to thereby interrupt the electrical communication between the first terminal and the first electrode or between the second terminal and the second electrode.

2. (canceled)

3. The battery of claim 1, wherein the insulation is electrical insulation that interrupts current flow from a charger that charges the battery to either the first terminal or the second terminal.

4. The battery of claim 3, wherein the electrical insulation is a thermal fuse.

5. The battery of claim 4, wherein the thermal fuse is i) at or over a portion of the outer surface of the cell casing, or ii) at one of the terminals that receives the current flow from the charger.

6. The battery of claim 1, wherein the insulation is a non-porous, non-conductive barrier between the electrode assembly and the cell casing.

7. The battery of claim 6, wherein the non-porous, non-conductive barrier is a non-porous, non-conductive coating, tape, wrap, sleeve or bag.

8. The battery of claim 7, wherein the non-porous, non-conductive barrier is a non-porous, non-conductive coating, and wherein the non-porous, non-conductive coating coats at least a portion of the interior surface of the cell casing.

9. The battery of claim 8, wherein the non-porous, non-conductive coating includes Al₂O₃ and/or SiO₂.

10. The battery of claim 9, wherein the non-porous, non-conductive coating includes Al₂O₃.

11. The battery of claim 10, wherein the Al₂O₃ coating has a thickness in a range of between about 5 microns and about 50 microns.

12. The battery of claim 11, wherein the Al₂O₃ coating has a thickness in a range of between about 5 microns and about 15 microns.

13. The battery of claim 9, wherein the non-porous, non-conductive coating further coats at least a portion of the exterior surface of the cell casing.

14. The battery of claim 13, further comprising a lid over the cell casing, and wherein the coated portion of the exterior surface of the cell casing with the non-porous, non-conductive coating is other than a portion that is in contact with the lid.

15. The battery of claim 14, wherein at least a portion of the lid is in electrical communication with the second terminal.

16. The battery of claim 7, wherein the non-porous, non-conductive barrier is a non-porous, non-conductive tape or wrap.

17. The battery of claim 16, wherein the electrode assembly is in a jelly-roll configuration.

18. The battery of claim 17, wherein the non-porous, non-conductive tape or wrap extends from the end of the jelly roll and wraps the outer wall of the jelly roll.

19. The battery of claim 7, wherein the non-porous, non-conductive barrier is the non-porous, non-conductive sleeve or bag that contains the electrode assembly.

20. The battery of claim 1, further including a lid over the cell casing, wherein the lid is made of a conductive material.

21. The battery of claim 20, wherein the conductive material is a metal.

22. The battery of claim 21, wherein the cell casing and the lid are made of a metal that includes aluminum.

23. The battery of claim 1, wherein the current interrupt device is in electrical communication with the second terminal and with the second electrode.

24. The battery of claim 23, wherein the lid is in electrical communication with the second terminal.

25. The battery of claim 24, wherein the current interrupt device is at the lid.

26. A battery pack, comprising at least one cell and at least one charger that charges the cell, wherein each cell includes:
a) a cell casing
b) a first terminal
c) a second terminal in electrical communication with the cell casing and electrically insulated from the first terminal;
d) an electrode assembly in the cell casing, the electrode assembly including a first electrode in electrical communication with the first terminal, a second electrode in electrical communication with the second terminal, and an electrolyte between the first and second electrodes;
e) a current interrupt device in electrical communication with the first terminal and the first electrode, or with the second terminal and the second electrode, the current interrupt device including a first conductive component and a second conductive component in electrical communication with each other, wherein the electrical communication between the first and second conductive components is interrupted when a gauge pressure between the two components is in a range of between about 4 kg/cm² and about 15 kg/cm²; and
f) insulation that interrupts potential electrochemical communication between the first electrode and the second terminal or between the second electrode and the first terminal, when under a charging or overcharging condition and when the electrical communication between the first and second conductive components of the current interrupt device has been interrupted to thereby interrupt the electrical communication between the first terminal and the first electrode or between the second terminal and the second electrode,
and wherein the charger is in electrical communication with the first terminal or the second terminal of the cell.

27. (canceled)

28. The battery pack of claim 26, wherein the insulation is electrical insulation that interrupts current flow from a charger that charges the battery to either the first terminal or the second terminal.

29. The battery pack of claim 28, wherein the electrical insulation is a thermal fuse.

30. The battery pack of claim 29, wherein the thermal fuse is i) at or over a portion of the outer surface of the cell casing, or ii) at one of the terminals that receives the current flow from the charger.

31. The battery pack of claim 26, wherein the insulation is a non-porous, non-conductive barrier between the electrode assembly and the cell casing.

32. The battery pack of claim 31, wherein the non-porous, non-conductive barrier is a non-porous, non-conductive coating, tape, wrap, sleeve or bag.

33. The battery pack of claim 32, wherein the non-porous, non-conductive barrier is a non-porous, non-conductive coating, and wherein the non-porous, non-conductive coating coats at least a portion of the interior surface of the cell casing.

34. The battery pack of claim 33, wherein the non-porous, non-conductive coating includes Al₂O₃ and/or SiO₂.

35. The battery pack of claim 34, wherein the non-porous, non-conductive coating includes Al₂O₃.

36. The battery pack of claim 35, wherein the Al₂O₃ coating has a thickness in a range of between about 5 microns and about 50 microns.

37. The battery pack of claim 36, wherein the Al₂O₃ coating has a thickness in a range of between about 5 microns and about 15 microns.

38. The battery pack of claim 34, wherein the non-porous, non-conductive coating further coats at least a portion of the exterior surface of the cell casing.

39. The battery pack of claim 38, further comprising a lid over the cell casing, and wherein the coated portion of the exterior surface of the cell casing with the non-porous, non-conductive coating is other than a portion that is in contact with the lid.

40. The battery pack of claim 39, wherein at least a portion of the lid is in electrical communication with the second terminal.

41. The battery pack of claim 32, wherein the non-porous, non-conductive barrier is a non-porous, non-conductive tape or wrap.

42. The battery pack of claim 41, wherein the electrode assembly is in a jelly-roll configuration.

43. The battery pack of claim 42, wherein the non-porous, non-conductive tape or wrap extends from the end of the jelly roll and wraps the outer wall of the jelly roll.

44. The battery pack of claim 32, wherein the non-porous, non-conductive barrier is a non-porous, non-conductive sleeve or bag that contains the electrode assembly.

45. The battery pack of claim 26, further comprising a lid over the cell casing, and wherein the lid is made of a conductive material.

46. The battery pack of claim 45, wherein the conductive material is a metal.

47. The battery pack of claim 46, wherein the cell casing and the lid are made of a metal that includes aluminum.

48. The battery pack of claim 26, wherein the current interrupt device is in electrical communication with the second terminal and the second electrode.

49. The battery pack of claim 48, wherein the lid is in electrical communication with the second terminal.

50. The battery pack of claim 49, wherein the current interrupt device is at the lid.

51. A method of minimizing increase of internal pressure of at least one cell of a battery pack under a charging or overcharging condition, comprising:
a) charging at least one cell of the battery pack with a charger of the battery pack that is in electrical communication with a first terminal or a second terminal of the cell, the first and the second terminals being in electrical communication with a first electrode and a second electrode of an electrode assembly of the cell, respectively;
b) interrupting electrical communication between the first terminal and the first electrode of the cell or between the second terminal and the second electrode of the cell by a current interrupt device that includes a first conductive component and a second conductive component in electrical communication with each other, when a gauge pressure between the components is in a range of between about 4 kg/cm² and about 15 kg/cm²; and
c) interrupting potential electrochemical communication between the first electrode and the second terminal or between the second electrode and the first terminal with insulation.

52. The method of claim 51, wherein the insulation is at least one of:
i) a non-porous, non-conductive barrier between the electrode assembly and the cell casing; and
ii) electrical insulation that interrupts current flow from a charger that charges the battery to either the first terminal or the second terminal.

53. A method of forming a battery, comprising the step of forming insulation as a component of the battery,
wherein the battery further includes a current interrupt device in electrical communication with a first terminal and a first electrode, or with a second terminal and a second electrode, of the battery, the current interrupt device including a first conductive component and a second conductive component in electrical communication with each other, the electrical communication between the first and second conductive components being interrupted when a gauge pressure between the two components is in a range of between about 4 kg/cm² and about 15 kg/cm²,
and wherein the insulation interrupts potential electrochemical communication between the first electrode and the second terminal or between the second electrode and the first terminal of the battery when under a charging or overcharging condition and when the electrical communication between the first and the second components of the current interrupt device is interrupted to thereby interrupt the electrical communication between the first terminal and the first electrode or between the second terminal and the second electrode.

54. The method of claim 53, wherein the insulation is at least one of:
i) a non-porous, non-conductive barrier between the electrode assembly and the cell casing; and
ii) electrical insulation that interrupts current flow from a charger that charges the battery to either the first terminal or the second terminal.
